(19) United States
(12) Patent Application Publication
(10) Pub. No.: US 2026/0124951 A1
(43) Pub. Date: May 7, 2026

(54) MOBILE ELECTRICAL POWER DISTRIBUTION SYSTEM, AND METHOD OF DELIVERING THEREOF

(71) Applicant: Charles Waugh, Georgetown, IN (US)

(72) Inventor: Charles Waugh, Georgetown, IN (US)

(21) Appl. No.: 19/382,243

(22) Filed: Nov. 6, 2025

Related U.S. Application Data
(60) Provisional application No. 63/716,931, filed on Nov. 6, 2024.

(51) Int. Cl. B60L 53/68; B60L 53/30; B60L 53/302; B60L 53/51; B60L 53/53

(52) U.S. Cl. CPC B60L 53/68; B60L 53/302; B60L 53/305; B60L 53/51; B60L 53/53; B60L 2210/20

(57) ABSTRACT

The present disclosure provides a deployable power distribution system comprising a housing unit. The housing unit may include one or more input connectors which may be configured for receiving an electrical input from one or more external sources. Also, the housing unit may include one or more transformer modules electrically coupled with the one or more input connectors. Further, the one or more transformer modules may be configured for modifying one or more attributes of the electrical input. The one or more transformer modules may be configured for generating an electrical output based on the modifying of the one or more attributes. Also, the housing unit may include one or more output connectors electrically coupled with the one or more transformer modules. Further, the one or more output connectors may be configured for distributing the electrical output to one or more loads.

### CROSS-REFERENCE TO RELATED APPLICATION

This application claims the benefit of U.S. Provisional Application No. 63/716,931 filed on Nov. 6, 2024, the contents of which are hereby incorporated by reference.

### TECHNICAL FIELD

The present disclosure relates to the field of equipment for distribution of energy. More specifically, the present disclosure relates to a system and method of deploying a mobile electrical power distribution system.

### BACKGROUND

The field of mobile electrical energy distribution and electric vehicle (EV) charging systems is of growing importance as electric mobility, distributed renewable generation, and emergency power access have become essential components of modern infrastructure. Reliable and flexible power delivery systems are critical not only for supporting the expanding network of electric vehicles but also for ensuring energy availability in situations where fixed infrastructure is unavailable, damaged, or insufficient. The capability to rapidly deploy portable energy systems contributes significantly to grid resilience, emergency response, and sustainable electrification efforts across diverse environments.

In the given field, a highly desirable aspect is to develop portable and adaptive systems capable of delivering electric power to vehicles and external devices in a manner that is efficient, safe, and responsive to varying conditions of supply and demand. An additional desirable feature of such systems is the ability to function effectively across multiple scenarios, including urban expansion, temporary installations, event-based deployments, and disaster recovery operations, without necessitating extensive site-specific setup or long-term infrastructural modification.

Further, installation of stationary electric vehicle supply equipment (EVSE) is labor-intensive, disruptive to the surrounding infrastructure, and typically designed for permanent use at fixed locations. Further, in disaster situations, loss of electricity may result in life-threatening consequences. Existing solutions lack a rapidly deployable method for transferring power from electric vehicles to external devices, or for establishing mobile charging hubs.

Accordingly, there exists a need for a portable and configurable energy delivery system that may be quickly deployed, connected to a variety of power sources, and serve as both a charging hub for EVs and a power distribution point for critical loads.

Moreover, existing power distribution and charging systems often encounter multiple limitations that impede the attainment of the said objectives. Stationary electric vehicle charging installations typically require significant civil works, grid upgrades, and permitting, which limit the existing system's suitability for rapid deployment. Conventional backup or portable power systems tend to be bulky, fragmented, or incapable of supporting simultaneous vehicle charging and auxiliary power distribution. Furthermore, existing solutions generally lack effective mechanisms for adaptive power control, real-time monitoring, and seamless interconnection between grid-tied, generator-fed, and renewable sources. As a result, the said systems frequently fail to provide reliable power access in remote, mobile, or disrupted environments.

In addition, the management of power flow in multi-source configurations often remains inefficient, with challenges in load balancing, source switching, and diagnostic oversight. Environmental factors such as temperature, vibration, and exposure to adverse weather conditions may further degrade performance and safety. Moreover, the absence of intelligent automation and predictive analytics in existing designs leads to unanticipated downtime and maintenance difficulties, especially when remote access or supervision is required.

Therefore, there is a need for improved deployable power distribution systems that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a deployable power distribution system. Further, the deployable power distribution system may include a housing unit. Further, the housing unit may include one or more input connectors which may be configured for receiving an electrical input from one or more external sources. Further, the housing unit may include one or more transformer modules electrically coupled with the one or more input connectors. Further, the one or more transformer modules may be configured for modifying one or more attributes of the electrical input. Further, the one or more transformer modules may be configured for generating an electrical output based on the modifying of the one or more attributes. Further, the housing unit may include one or more output connectors electrically coupled with the one or more transformer modules. Further, the one or more output connectors may be configured for distributing the electrical output to one or more loads.

The present disclosure provides a deployable power distribution system. Further, the deployable power distribution system may include a housing unit. Further, the housing unit may include one or more input connectors which may be configured for receiving an electrical input from one or more external sources. Further, the housing unit may include one or more transformer modules electrically coupled with the one or more input connectors. Further, the one or more transformer modules may be configured for modifying one or more attributes of the electrical input. Further, the one or more transformer modules may be configured for generating an electrical output based on the modifying of the one or more attributes. Further, the housing unit may include one or more output connectors electrically coupled with the one or more transformer modules. Further, the one or more output connectors may be configured for distributing the electrical output to one or more loads. Further, the deployable power distribution system may include a communication module disposed within the housing unit. Further, the communication module may be configured for receiving one or more commands from one or more devices. Further, the one or more commands includes a distribution command for distributing the electrical output. Further, the deployable power distribution system may include a processor communicatively coupled with the communication module and the one or more output connectors. Further, the processor may be configured for analyzing the one or more commands. Further, the processor may be configured for initiating the distributing of the electrical output to the one or more loads based on the analyzing of the one or more commands.

The present disclosure provides a deployable power distribution system. Further, the deployable power distribution system may include a housing unit. Further, the housing unit may include one or more input connectors which may be configured for receiving an electrical input from one or more external sources. Further, the housing unit may include one or more transformer modules electrically coupled with the one or more input connectors. Further, the one or more transformer modules may be configured for modifying one or more attributes of the electrical input. Further, the one or more transformer modules may be configured for generating an electrical output based on the modifying of the one or more attributes. Further, the housing unit may include one or more output connectors electrically coupled with the one or more transformer modules. Further, the one or more output connectors may be configured for distributing the electrical output to one or more loads. Further, the one or more loads includes one or more chargeable devices. Further, the deployable power distribution system may include one or more charging modules electrically coupled with the one or more output connectors. Further, the distributing of the electrical output to the one or more loads includes charging the one or more chargeable devices using the one or more charging modules.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front sectional view of a deployable power distribution system according to an embodiment.

FIG. 2 is another front sectional view of the deployable power distribution system according to an embodiment.

FIG. 3 is a perspective view of the deployable power distribution system according to an embodiment.

FIG. 4 is another front sectional view of the deployable power distribution system according to an embodiment.

FIG. 5 is another front sectional view of the deployable power distribution system according to an embodiment.

FIG. 6 is another front sectional view of the deployable power distribution system according with an embodiment.

FIG. 7 is another front sectional view of the deployable power distribution system according with an embodiment.

FIG. 8A is another perspective view of the deployable power distribution system according to an embodiment.

FIG. 8B is another perspective view of the deployable power distribution system according with an embodiment.

FIG. 9 is another perspective view of the deployable power distribution system according to an embodiment.

FIG. 10 is a cross-sectional view of a deployable power distribution system 1000 according to an embodiment.

FIG. 11 is another perspective view of the deployable power distribution system according to an embodiment.

FIG. 12 is a side view of a deployable power distribution system according to an embodiment.

FIG. 13 is another front sectional view of a deployable power distribution system according to an embodiment.

FIG. 14 is another front sectional view of a deployable power distribution system according to an embodiment.

FIG. 15 is an online platform 1500 consistent with various embodiments of the present disclosure.

FIG. 16 is a block diagram of a computing device for implementing the methods disclosed herein, in accordance with an embodiment.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The system disclosed in the present disclosure relates generally to mobile energy storage and distribution systems. More particularly, the present disclosure relates to a deployable containerized unit for providing electric vehicle (EV) charging and auxiliary power delivery in stationary or disaster-response environments.

The present disclosure provides a Mobile Electric Vehicle Power Access Container (MEVPAC), a shipping container-based system housing configured electrical loads. The MEVPAC integrates:
A high-capacity power distribution system (e.g., MP800 or MP1200 configuration) enclosed within a shipping container.
Connections to accept power from multiple sources, including grid-tied and generator inputs, via cam-lock or UL-listed connectors.
Integrated charging infrastructure capable of supporting Level 2 and Level 3 EVSE with standard connectors (SAE J1772, CCS, etc.).
Communication and monitoring components, including Wi-Fi, satellite connectivity, point-of-sale interfaces, and remote diagnostic capability.
Optional fire suppression systems to meet NFPA and UL standards.

Further, the MEVPAC is rapidly deployable, scalable, and enables reliable power delivery in both routine and emergency use cases.

Further, the Mobile Electric Vehicle Power Access Container (MEVPAC) is implemented within a standard 20-foot or 40-foot shipping container. The unit contains an electrical distribution system configured as either:
MP800: 800 A, three-phase, 600 V-rated Delta primary service with a secondary transformer providing 120/240 V single-phase or 208 V three-phase current.
MP1200: 1200 A, three-phase, 600 V-rated Delta primary service with secondary transformer delivering 120/240 V single-phase and/or 208 V three-phase current.

Further, the container is designed to connect to equivalent power generation sources, including grid-tied service or generator (genset) units. Rapid connection is facilitated by cam-style locking mechanisms or UL-listed connectors housed within a protected enclosure.

Further, the system supports up to six Level 3 EV chargers and includes a 400 A, 120/208 V secondary panel for Level 2 chargers. Cable management accommodates SAE J1772, CCS, and future EVSE hardware, as well as inductive charging apparatus.

Further, the MEVPAC may be outfitted with satellite communication modules, Wi-Fi routers, point-of-sale payment systems, and remote monitoring and telemetry.

Further, the system is designed to comply with NFPA standards, UL listings, and may include fire suppression systems adapted to EVSE fire hazards.

Further, the system allows for the rapid deployment for EV charging in remote or underdeveloped regions, mobile charging hubs for events, disaster response scenarios where grid power is unavailable, and auxiliary power provision for critical loads using EVs as distributed energy resources.

In some embodiments, the present disclosure may describe a mobile electric vehicle power access apparatus. Further, the mobile electric vehicle power access apparatus may include a shipping container defining an interior compartment. Further, the mobile electric vehicle power access apparatus may include an electrical distribution assembly housed within the interior compartment and comprising a transformer configured to convert a three-phase, 600 V delta primary input to at least one of 120/240 V single-phase or 120/208 V three-phase secondary outputs. Further, the mobile electric vehicle power access apparatus may include a plurality of power-input connectors mounted on the shipping container and including at least one cam-style locking connector and at least one UL-listed connector, each configured to receive power from an external source selected from a grid service or a generator. Further, the mobile electric vehicle power access apparatus may include a charging assembly within the interior compartment comprising a plurality of EVSE modules, including at least one Level 2 EVSE interface and at least one Level 3 EVSE interface. Further, each EVSE interface may be coupled to the secondary outputs. Further, the mobile electric vehicle power access apparatus may include a cable management system affixed to the shipping container and configured to stow cables associated with the EVSE modules. Further, the mobile electric vehicle power access apparatus may include a communication and monitoring subsystem including at least one of a Wi-Fi transceiver, a satellite communication module, and a point-of-sale interface. Further, the mobile electric vehicle power access apparatus may include a fire suppression system disposed within the interior compartment.

In some embodiments, the present disclosure may describe a mobile power distribution system. Further, the mobile power distribution system may include a shipping container. Further, the mobile power distribution system may include an electrical distribution system housed within the shipping container, the system configured to provide at least one of 120/240 V single-phase or 208 V three-phase current from a primary three-phase 600 V delta input. Further, the mobile power distribution system may include a plurality of connectors configured to receive power from an external source, including at least one of a grid connection or a generator. Further, the mobile power distribution system may include at least one electric vehicle supply equipment (EVSE) interface housed in or coupled to the container.

Further, the mobile power distribution system may include a plurality of Level 2 and Level 3 EVSE interfaces configured for SAE J1772, CCS, or inductive charging.

Further, the electrical distribution system may be rated at 800 A or 1200 A.

Further, the mobile power distribution system may include communication and monitoring components including satellite connectivity, Wi-Fi, and a point-of-sale interface.

Further, the mobile power distribution system may include a fire suppression system compliant with NFPA standards.

In some embodiments, the present disclosure describes a method for deploying and operating a containerized mobile electric vehicle charging and auxiliary power distribution system. Further, the method may include a step of transporting to a deployment site a shipping container defining an interior compartment and housing an electrical distribution assembly. Further, the electrical distribution assembly may include a transformer configured to convert a three-phase, 600 V delta primary input to at least one secondary 120/240 V single-phase and 120/208 V three-phase, a plurality of power-input connectors including at least one cam-style locking connector and at least one UL-listed connector, a plurality of EVSE modules supporting Level 2 and Level 3 charging, a cable management subsystem, and a communication subsystem. Further, the method may include a step of coupling the power-input connectors to an external power source selected from a grid service and a generator. Further, the method may include a step of connecting at least one of the EVSE modules to an electric vehicle and supplying charging power thereto via the secondary output. Further, the method may include a step of distributing auxiliary power to an external load via the secondary output. Further, the method may include a step of stowing and deploying charging cables using the cable management subsystem. Further, the method may include a step of transmitting operational and diagnostic data from the communication subsystem to a remote monitoring station. Further, the method may include a step of receiving a remote control command via the communication subsystem and adjusting a power distribution parameter of at least one of the electrical distribution assembly or the EVSE modules in response to the remote control command.

Further, in some embodiments, the present disclosure may describe a method of providing deployable power distribution. Further, the method may include a step of transporting a shipping container housing an electrical distribution system to a site. Further, the method may include a step of connecting the system to an external power source selected from a grid connection or a generator. Further, the method may include a step of supplying electric vehicle charging through at least one EVSE interface. Further, the method may include a step of distributing auxiliary power to external devices through secondary output panels.

In some embodiments, the present disclosure may describe a mobile electric vehicle power access system. Further, the mobile electric vehicle power access system may include a shipping container defining an interior compartment. Further, the mobile electric vehicle power access system may include an electrical distribution assembly housed within the interior compartment. Further, the electrical distribution assembly may include a transformer configured to convert a three-phase, 600 V delta primary input to at least one secondary output selected from 120/240 V single-phase and 120/208 V three-phase. Further, the mobile electric vehicle power access system may include a plurality of power-input connectors mounted on the shipping container. Further, the plurality of power-input connectors may include at least one cam-style locking connector and at least one UL-listed connector, each configured to receive power from an external source selected from a grid connection or a generator. Further, the mobile electric vehicle power access system may include a charging assembly within the interior compartment. Further, the charging assembly may include a plurality of electric vehicle supply equipment (EVSE) modules. Further, the plurality of EVSE modules may include at least one Level 2 SAE J1772 interface and at least one Level 3 Combined Charging System interface, each EVSE module electrically coupled to the secondary output. Further, the mobile electric vehicle power access system may include a cable management system affixed to the shipping container and configured to stow and deploy cables associated with the EVSE modules. Further, the mobile electric vehicle power access system may include a communication and monitoring subsystem. Further, the communication and monitoring subsystem may include at least one of a Wi-Fi transceiver, a satellite communication module, and a point-of-sale interface. Further, the mobile electric vehicle power access system may include a fire suppression system disposed within the interior compartment.

Further, the present disclosure:
Provides users with a shipping container system with a configured power load of MP800 or MP1200 is housed inside the unit.
Functions as an energy delivery system that is rapidly deployable and accepts equivalent power from any source with a primary overcurrent device or branch circuit overcurrent protection.
Features cam-style locking mechanisms and/or solidly connected via UL-listed and rated connectors inside an enclosed housing and proprietary connection apparatus.
Accommodates satellite connectivity, Wi-Fi, point of sale interface, remote monitoring, level 2 and level 3 EV charging components with cable management systems for SAE J1772, CCS, and future EVSE connection hardware and inductive charging apparatuses.
Accepts any power generation source, like grid-tied or genset connections in disaster response situations.

Further, the Mobile Electric Vehicle Power Access Container (MEVPAC) is a shipping container device. The device is comprised of a configured power load housed inside a shipping container in either MP800 or MP1200. The device includes a 480V, 3 ph Delta configuration and accommodations for six level 3 EV chargers, as well as a 400 amp 120 208V secondary panel for level two chargers. The device is designed to accept any equivalent power generation source, including grid-tied or Gen-set connected in disaster response situations via built-in connection utilizing cam lock style connections for rapid deployment.

Further, the energy delivery system is rapidly deployable and accepts equivalent power from any source with a primary overcurrent device and/or branch circuit overcurrent protection. MEVPAC is housed inside a portable shipping container with cam-style locking mechanisms and/or solidly connected via UL-listed and rated connectors, in an enclosed housing and proprietary connection apparatus to any NFPA requirements. MEVPAC units may be designed to accommodate satellite connectivity, Wi-Fi, point of sale interface, remote monitoring, level 2 and level 3 EV charging components with cable management systems for SAE J1772, CCS, and future EVSE connection hardware and inductive charging apparatus. The MEVPAC is designed to accommodate NFPA and UL-listed fire suppression systems of engineered specifications of inboard and outboard components and future EV fire suppression technology.

Further, the MP800 is an 800 ampere, three-phase 600V-rated delta primary service with a secondary transformer delivering 120/240 Volts single-phase or 208 Volts three-phase current and housed inside a 20′ container. The MP1200 is a 1200 ampere, three-phase 600V-rated delta primary service with a secondary transformer delivering 120/240V single-phase current, 208 Volts three-phase current, and housed inside a 20′ or 40′ container.

In some embodiments, the system may include a 10-foot container housing two 80 KW Chargers. Further, the system may include 480 amperes, 277 Volt service. Further, the system may include a 30 KVA transformer and a 100 amperes 122.08 Volt secondary, and a Satellite uplink. Further, the system may include a 55-inch forward-facing display, a proprietary host PC, and users may team view into the system now. Further, the housing unit may include roll-up doors. Further, the roll-up doors may be automated.

Further, in some embodiments, the system may facilitate Plug and Play connectivity. Further, the deployment and functionality stay the same, mathematically cut in half of what the system was doing.

Further, the system may include an overhead bulb, an underground conversion, a metering cabinet, and a breaker. Further, the breaker allows users to throw a switch and isolate the MEVPAC from the permanently connected grid. Further, the PACTAP is where the user's connection points are right in each phase. Further, the user may be able to roll out, roll up, plug in, or, if the Grid's down, the user may throw that switch to turn the system off, unplug the system, and plug the system up to a generator. So, PACTAP is meant to connect from the charger to the grid. The advantage of PACTAP is being an all-in-one, self-contained, pre-assembled unit.

Further, the system may include an HVAC cooling unit built into the container and swing-away doors for access.

Further, in an embodiment, as an example, to provide a three-phase current from a primary three-phase 600 V delta input: Where voltage is 480V at 26.6 kw

Current is 32 A-40 A

To calculate three-phase electrical power,

$$P = I \times E \times {P}_{f} \times 1.73 ,$$

Where P is power, I is current, E is Voltage, P_{f} is power factor representing the phase difference between voltage and current, and 1.73 is a constant

$$P = 32 \times 480 \times 0.95 \times 1.73 = 25 , 244 watts$$

Further,

$$25 , 244 w \times 8 = 201 , 953 w \times 1.25 = 252 , 441 watts / 1000 = 252 kw$$

For 3 phase AMPS,

$$Current I = ( 1000 \times 252.4 kw ) / ( {3}^{1 / 2} \times 0.95 \times 480 ) = 252 \; 400 / 78 \; 9.81 = 319.57 Full Load Amperes ( FLA )$$

Alternatively,

$$I = ( 1000 \times 265.6 ) / ( {3}^{1 / 2} \times 0.95 \times 480 ) = 265 \; 600 / 78 \; 9.81 = 336.2 FLA$$

Additionally,

$$( 265600 + 750 \; 00 ) / 78 \; 9.81 = 431.24 FLA = 358.52 kw = 480 V total load$$

Meanwhile,

$$600 \times 0.8 = 480 A$$

In some embodiments, the system inherently improves the technology of mobile power distribution and EV charging systems through the integration of modular, communication-enabled, and rapidly deployable electrical architectures.

In some embodiments, the MEVPAC may include a modular transformer configuration (e.g., MP400, MP800, or MP1200) that dynamically adjusts the output voltage and current phase balancing based on the real-time charging load of connected EVSE modules. The given feature solves the technical problem of uneven load distribution and inefficiency in multi-charger systems.

In some embodiments, adaptive load balancing may be performed by real-time monitoring of current draw through embedded current transformers (CTs) interfaced with a microcontroller-based control unit. The control unit may redistribute power flow across multiple secondary windings or employ phase-angle modulation to maintain equilibrium across all connected chargers. In one implementation, the adaptive load balancing algorithm may execute on a local processing unit and may communicate via Modbus TCP or MQTT to a remote monitoring system. In another embodiment, the system may employ artificial intelligence models trained to predict load imbalance patterns and proactively adjust phase sequencing. The given improvement directly enhances the electrical distribution efficiency technology, reducing transformer heating, improving power factor, and extending the operational lifespan of the distribution assembly.

In some embodiments, the system may include a Portable Automatic Connection Transfer and Access Panel (PACTAP) that enables seamless switching between grid-connected, generator-fed, or vehicle-based power sources. The given feature solves the problem of manual, error-prone switching between distinct power sources in field-deployable units.

In one embodiment, the PACTAP may comprise a multi-pole isolation switch, metering cabinet, and phase interlock assembly enabling hot-swappable power transition without physical rewiring. The control logic may detect voltage presence on all three phases, verify synchronization within a 2° phase angle, and engage a motorized relay array to complete the transfer.

In some embodiments, the given system may be implemented using industrial-grade contactors and digital synchronization modules similar to those used in automatic transfer switch (ATS) systems, but optimized for mobile containerized deployment. The specific technology improved here is power transfer and switching technology, enabling a self-contained, pre-assembled connection interface for mobile systems that previously required manual interconnection or separate enclosures.

In some embodiments, the MEVPAC may include satellite uplink communication, Wi-Fi, and cellular data interfaces for real-time telemetry and remote diagnostics. The given feature addresses the technical problem of limited connectivity in remote or disaster-stricken regions where traditional network infrastructure is unavailable. The system may employ a dual-modem gateway configured for satellite redundancy (e.g., Iridium or Starlink link) with a fall back to LTE/5G connectivity when available. The telemetry data may include voltage, current, harmonic distortion, and ambient temperature readings, which may be transmitted to a cloud monitoring system for predictive fault analytics.

In some embodiments, a local host PC integrated with the unit may run diagnostic visualization software and enable secure remote access through encrypted TeamViewer sessions. The given feature improves the IoT-based remote monitoring technology by combining multiple communication modalities in a ruggedized, mobile EVSE system, enabling remote management, fault detection, and over-the-air firmware updates.

In some embodiments, the container may be fitted with a swing-away door-mounted HVAC system that provides active cooling for electrical components while preserving full access to interior equipment. The given feature solves the problem of space constraints and inefficient airflow in containerized electrical systems. The swing-away mechanism may include a steel frame hinged to the container's vertical support structure and configured to support a one-and-a-half-ton refrigeration unit. The HVAC ducts may face inward, allowing for controlled air circulation through transformer and charger compartments.

Further, in some embodiments, the swing-away unit may incorporate vibration damping and quick-release refrigerant couplings for field servicing. The given feature improves thermal management technology in portable electrical systems by enabling efficient, maintainable, and compact HVAC integration without requiring fixed installations.

In some embodiments, the MEVPAC may include a predictive maintenance module that continuously monitors electrical performance parameters, such as harmonic distortion, temperature rise, and switching cycles, to identify early signs of degradation. The given feature addresses the technical problem of unexpected failure of critical power components in remote deployments. Further, the implementation may involve edge AI models trained on historical operational data stored locally or in the cloud. The models may identify deviations from normal patterns (e.g., transformer hum frequency drift, overcurrent spikes, or insulation resistance drop) and trigger alerts, enhancing electrical diagnostics technology, allowing pre-emptive maintenance and reducing system downtime.

In some embodiments, the system may support multiple EVSE standards, including SAE J1772, CCS, and inductive wireless charging, through modular interface ports. The cable management assembly may include retractable reels with motorized tension control, automatically stowing unused cables and maintaining safe clearance. The given feature solves the problem of inconsistent connector standards and cable clutter in mobile EVSE deployments, directly improving EV charging interface technology by allowing flexible interoperability and efficient cable handling.

In some embodiments, the MEVPAC may replace traditional magnetic transformers with solid-state transformers employing silicon carbide (SiC) MOSFETs and high-frequency resonant converters, improving power conversion technology, enabling faster response, reduced size, and increased efficiency. The SST may allow fine-grained voltage regulation and direct DC bus interfacing with EVSE modules, eliminating the need for bulky intermediate rectification.

In some embodiments, the MEVPAC may include a blockchain-verified transaction layer that enables secure peer-to-peer power exchange between multiple mobile units or connected EVs, addressing the problem of trustless and decentralized power trading within ad-hoc microgrids, improving energy distribution network technology, providing cryptographic verification and transparent audit of power flow events.

In some embodiments, the MEVPAC may include motorized stabilizers and autonomous wheel systems to self-deploy and level the container at uneven terrains, improving mechanical deployment technology, eliminating the need for manual alignment or heavy equipment. The stabilizers may include gyroscopic sensors, LIDAR mapping, and servo-controlled jacks that automatically calibrate the base tilt angle.

In some embodiments, the MEVPAC may integrate lithium iron phosphate (LiFePO₄) battery packs and solar input ports for renewable charging, addressing the problem of energy unavailability in off-grid conditions and improves energy sustainability technology by allowing the unit to operate autonomously for extended durations.

In some embodiments, the MEVPAC may include an augmented reality (AR) visualization system that overlays maintenance information via smart glasses or tablets, solving the technical problem of complex field maintenance without expert supervision.

Further, technicians may visualize live schematics of the electrical system, receive guided instructions, or view real-time thermal overlays, improving maintenance training technology, enhancing safety and operational uptime.

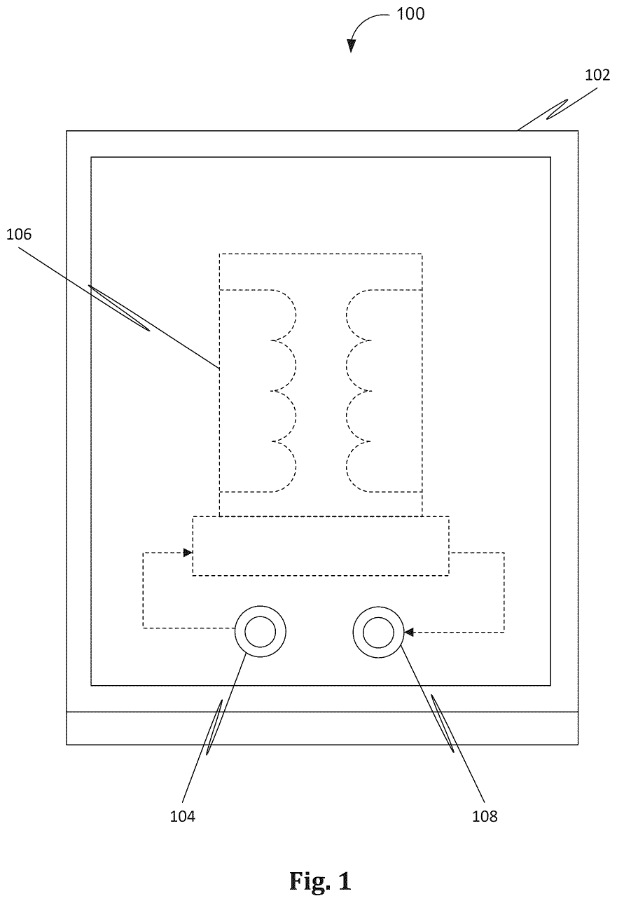

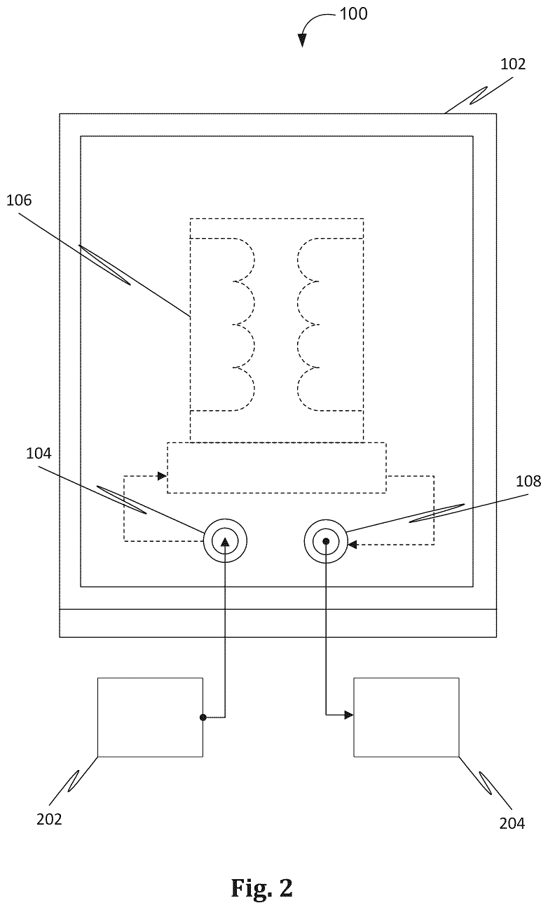

Now, referring to FIG. 1 and FIG. 2, a deployable power distribution system 100 is shown that may include a housing unit 102 (i.e., housing), one or more input connectors 104, one or more transformer modules 106, and one or more output connectors 108.

The one or more input connectors 104 is included in the housing unit 102, and may be configured for receiving an electrical input from one or more external sources 202 in FIG. 2.

The one or more transformer modules 106 is also included in the housing unit 102, and is electrically coupled with the one or more input connectors 104. Also, the one or more transformer modules 106 may be configured for modifying one or more attributes of the electrical input. Further, the one or more transformer modules 106 may be configured for generating an electrical output based on the modifying of the one or more attributes.

In some embodiments, the one or more transformer modules 106 include a 30 kVA transformer module. Also, the 30 kVA transformer module includes a primary winding connected to a 480 A and 277 V supply and a secondary winding rated at 100 A and 122.08 V.

In some embodiments, the one or more transformer modules 106 may include one or more of a first transformer unit and a second transformer unit. The first transformer unit includes a three-phase, delta-connected primary winding rated at 600 V and 800 A. Also, the second transformer unit includes a three-phase, delta-connected primary winding rated at 600 V and 1200 A.

The one or more output connectors 108 is further included in the housing unit 102, and is electrically coupled with the one or more transformer modules 106. Also, the one or more output connectors 108 may be configured for distributing the electrical output to one or more loads 204 as shown in FIG. 2.

In some embodiments, the electrical output from the one or more output connectors 108 may be one or more of a single-phase 120/240 V AC output and a three-phase 120/208 V AC output.

Referring now to FIG. 2 the front view of the deployable power distribution system 100 additionally has the one or more external sources 202 and the one or more loads 204 is shown.

The one or more external sources 202 may include one or more of a grid-tied system and a generator set system. Here, in some embodiments, the grid-tied system is a semi-autonomous electrical generation or grid energy storage system that links to the main electricity grid for drawing electricity from the main grid when available. In an embodiment, the grid-tied system may include a solar-based system where electric power may be drawn from solar panels for the power distribution system. Alternatively, the generator set system is a self-contained unit that combines an engine with an electric generator to produce electric power, and includes one or more of a diesel generator system and a natural gas generator system that supply electric power for the power distribution system.

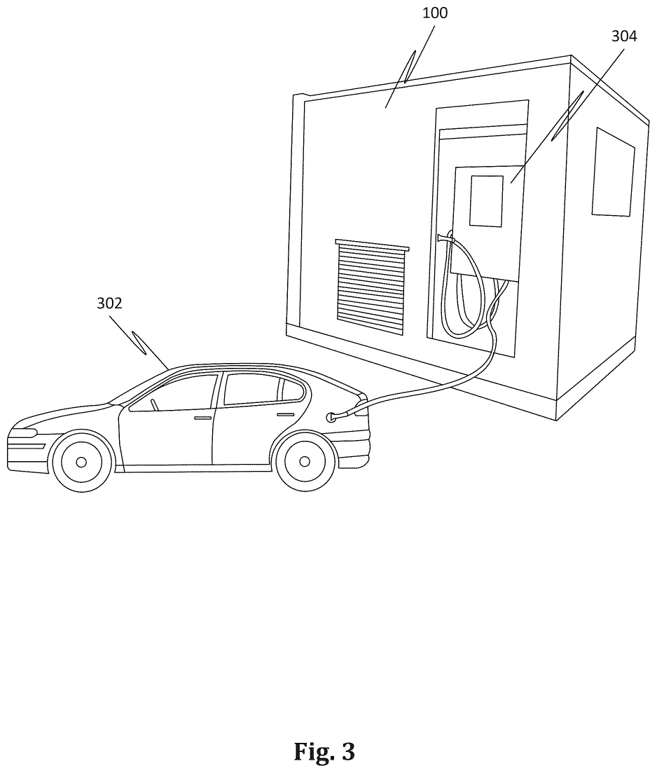

Referring to FIG. 3, a perspective view of the deployable power distribution system 100 is shown and includes one or more chargeable devices 302 and one or more charging modules 304.

In some embodiments, the one or more chargeable devices 302 may be included as part of the one or more loads 204 referred to in FIG. 2. In some embodiments, the one or more chargeable devices 302 may include one or more electrical vehicles.

The one or more charging modules 304 may be electrically coupled with the one or more output connectors 108 as previously described in FIGS. 1 and 2. Also, the distributing of the electrical output to the one or more loads 204 includes the use of the one or more charging modules 304 to charge the one or more chargeable devices 302.

Further, the one or more charging modules 304 may include one or more electric vehicle supply equipment. Also, the charging of the one or more chargeable devices 302 using the one or more charging modules 304 may include charging the one or more electrical vehicles using the one or more electric vehicle supply equipment. In some embodiments, the one or more electric vehicle supply equipment includes one or more of one or more Level 2 AC charging interfaces and one or more Level 3 DC charging interfaces.

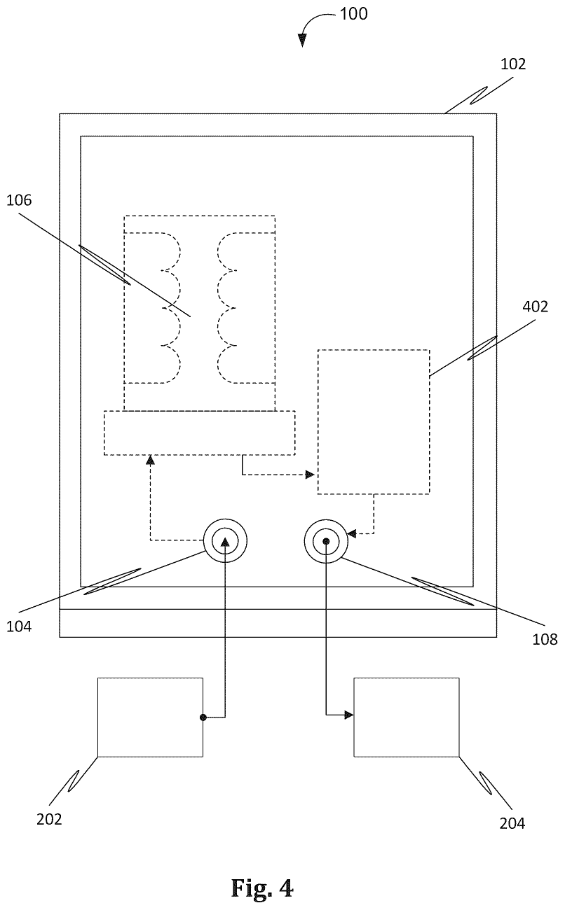

Referring to FIG. 4, a front view of the deployable power distribution system 100 is shown that includes one or more battery units 402 along with the previously described housing unit 102, the one or more input connectors 104, the one or more transformer modules 106, the one or more output connectors 108, the one or more external sources 202, and the one or more loads 204.

The one or more battery units 402 operatively coupled with the one or more transformer modules 106. Also, the one or more battery units 402 may be further electrically coupled with the one or more output connectors 108. Further, the one or more battery units 402 may be configured for storing the electrical output. Also, the distributing of the electrical output to the one or more loads 204 includes distributing the electrical output from the one or more battery units 402 to the one or more loads 204.

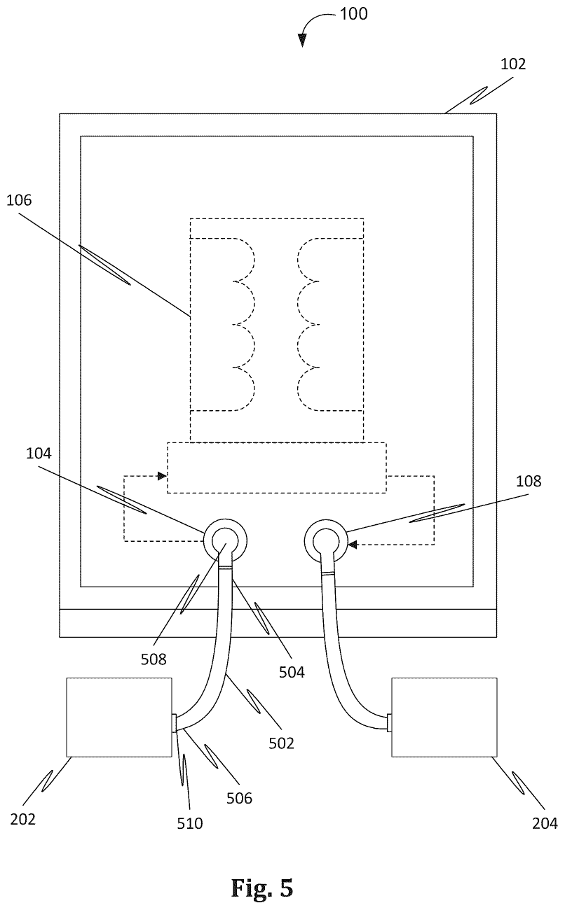

Referring to FIG. 5, the deployable power distribution system 100 including one or more connecting cables 502, a first cable end 504, a second cable end 506, a first cable connector, 508 and a second cable connector 510 along with the previously described housing unit 102, the one or more input connectors 104, the one or more transformer modules 106, the one or more output connectors 108, the one or more external sources 202, and the one or more loads 204. The one or more connecting cables 502 are used to receive the electrical input from the one or more external sources. Also, the one or more connecting cables 502 include a first cable end 504 and a second cable end 506. Here, the first cable end 504 may be coupled with the one or more input connectors 104, and the second cable end 506 may be coupled with the one or more external sources 202.

In some embodiments, the one or more connecting cables 502 include a first cable connector 508 disposed on the first cable end 504 and a second cable connector 510 disposed on the second cable end 506. Here, the first cable end 504 is coupled with the one or more input connectors 104 using the first cable connector 508. Similarly, the second cable end 506 is coupled with the one or more external sources 202 using the second cable connector 510.

In some embodiments, each of the first cable connector 508 and the second cable connector 510 may be one or more of one or more cam-style locking connectors and one or more UL-listed connectors.

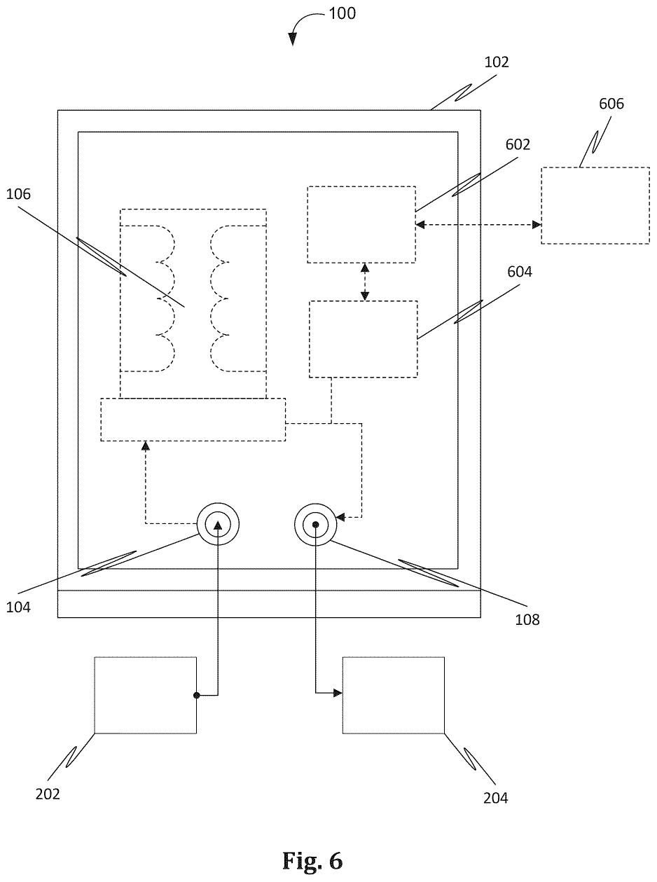

Referring to FIG. 6, the deployable power distribution system 100 includes a communication module 602 and a processor 604, along with the previously described housing unit 102, the one or more input connectors 104, the one or more transformer modules 106, the one or more output connectors 108, the one or more external sources 202, and the one or more loads 204.

In some embodiments, the communication module 602 is disposed within the housing unit 102. Also, the communication module 602 may be configured for receiving one or more commands from one or more external devices 606. Further, the one or more commands include a distribution command for distributing the electrical output.

The processor 604 is communicatively coupled with the communication module 602 and the one or more output connectors 108. Here, the processor 604 may be configured for analyzing the one or more commands. Additionally, the processor 604 may be configured for initiating the distributing of the electrical output to the one or more loads 204 based on the analyzing of the one or more commands.

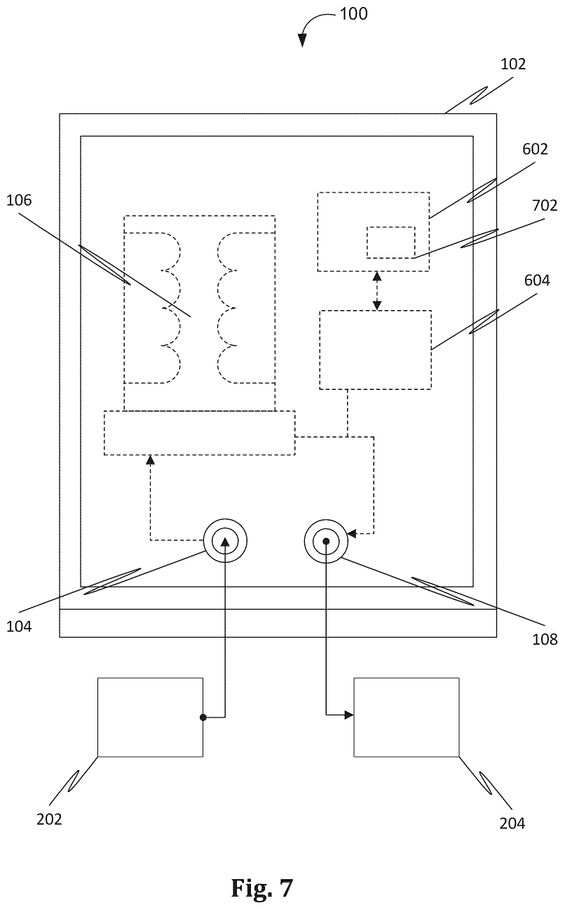

Referring to FIG. 7, the deployable power distribution system 100 includes a Wi-Fi transceiver module 702, along with the previously described housing unit 102, the one or more input connectors 104, the one or more transformer modules 106, the one or more output connectors 108, the one or more external sources 202, the one or more loads 204, the communication module 602 and the professor 604. The Wi-Fi transceiver module 702 may be included in the communication module 602, and may receive one or more commands from the one or more devices external devices 606 as described in FIG. 6.

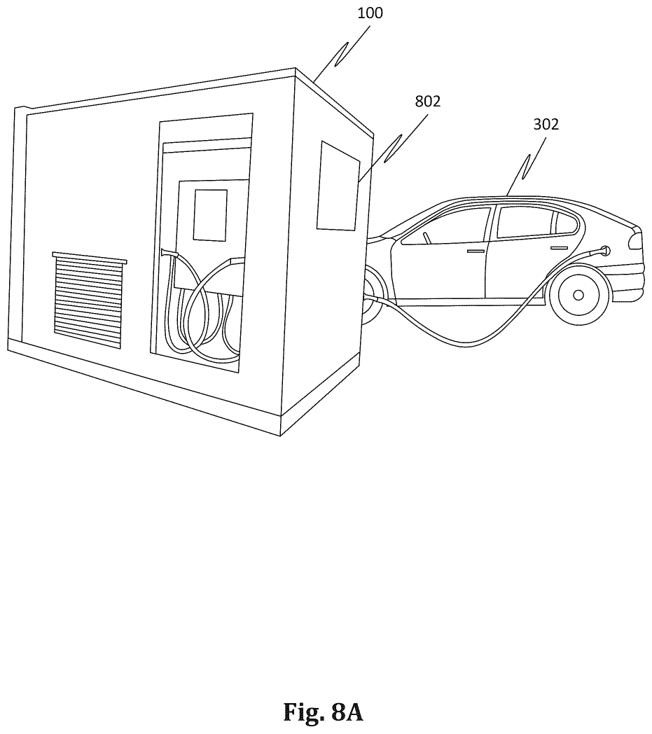

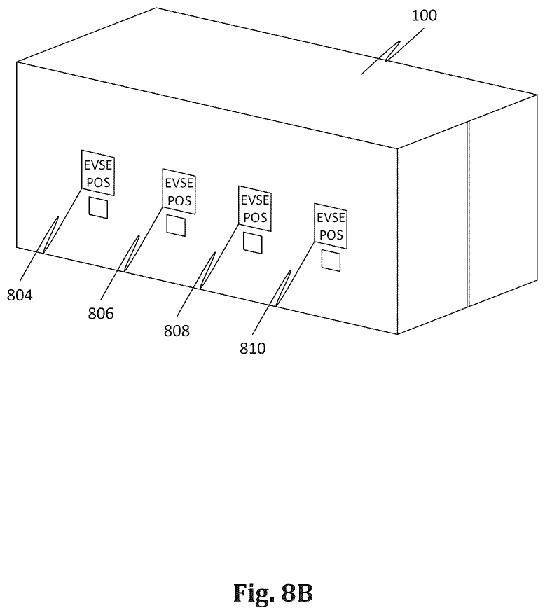

Referring to FIG. 8A and FIG. 8B illustrate the deployable power distribution system 100 including one or more presentation devices 802 configured for presenting one or more interfaces, in accordance with some embodiments. Further, in some embodiments, the one or more interfaces may include one or more Electrical Vehicle Supply Equipment (EVSE) point-of-sale interfaces (804, 806, 808, and 810).

Further, in some embodiments, the processor 604 may be further configured for determining one or more characteristics associated with the distributing of the electrical output to the one or more loads 204. Further, the processor 604 may be further configured for generating an interface data representing the one or more interfaces 802 based on determining of the one or more characteristics. Further, the deployable power distribution system 100 further includes the one or more presentation devices 802 disposed on the housing unit 102. Further, the one or more presentation devices 802 may be further communicatively coupled with the processor 604. Further, the one or more presentation devices 802 may be configured for presenting the one or more interfaces to one or more users based on the interface data.

In some embodiments, the one or more characteristics include a quantity of the electrical output. Further, the processing device may be further configured for generating a cost data based on the determining of the quantity of the electrical output. Further, the cost data represents a cost associated with the distributing of the electrical output. Further, the presenting of the one or more interfaces includes presenting the cost data to the one or more users.

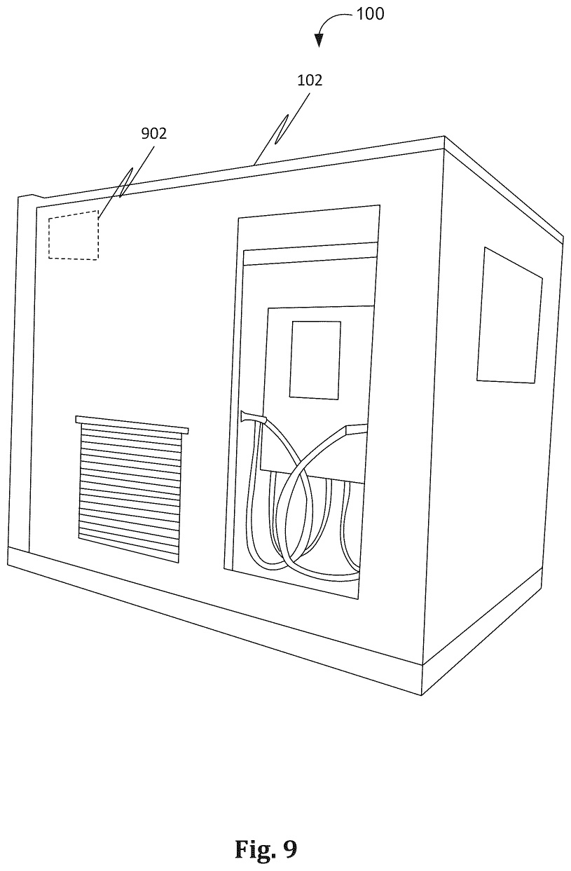

Referring to FIG. 9 the deployable power distribution system 100 including a fire suppression module 902, in accordance with some embodiments. Further, in some embodiments, the deployable power distribution system 100 further includes the fire suppression module 902 disposed within the housing unit 102. Further, in some embodiments, the fire suppression module 902 may be configured for monitoring a thermal condition associated with the deployable power distribution system 100. Further, the fire suppression module 902 may be configured for detecting one or more combustion events based on the monitoring of the thermal condition. Further, the fire suppression module 902 may be configured for discharging one or more fire suppressant materials based on the detecting of the one or more combustion events.

Further, in some embodiments, the processor 604 may be further configured for monitoring one or more operational parameters associated with the deployable power distribution system 100. Further, the processor 604 may be further configured for generating one or more diagnostic reports based on the monitoring of the one or more operational parameters. Further, the communication device 602 may be further configured for transmitting the one or more diagnostic reports to the one or more devices 606.

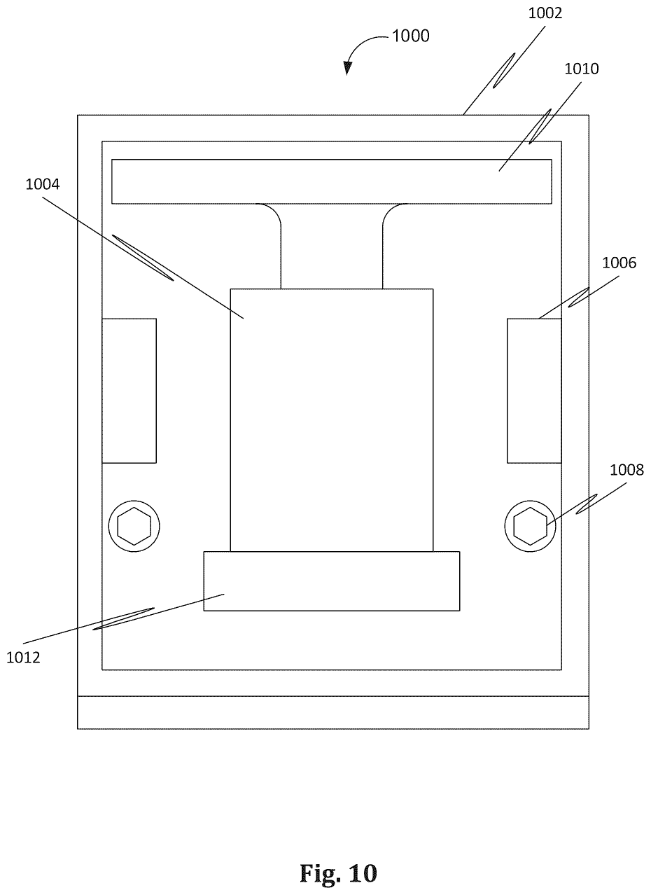

Referring to FIG. 10, a deployable power distribution system 1000 including a housing unit 1002, one or more transformer 1004, an Electrical Vehicle Supply Equipment (EVSE) 1006, a cable management unit 1008, and a cable tray 1010, and a tapbox/cam-lock enclosure 1012 are shown. In some embodiments, the cable management unit 1008 is disposed within a housing unit 1002. Also, the cable management unit 1008 facilitates one or more of a structured deployment and containment of the one or more connecting cables. Further, the cable management unit 1008 may include a retractable cable management unit.

The EVSE 1006 may include a 7-19 kW (i.e., 19.2 kW) Level 2 charger or a 50-350 kW+Level 3 charger.

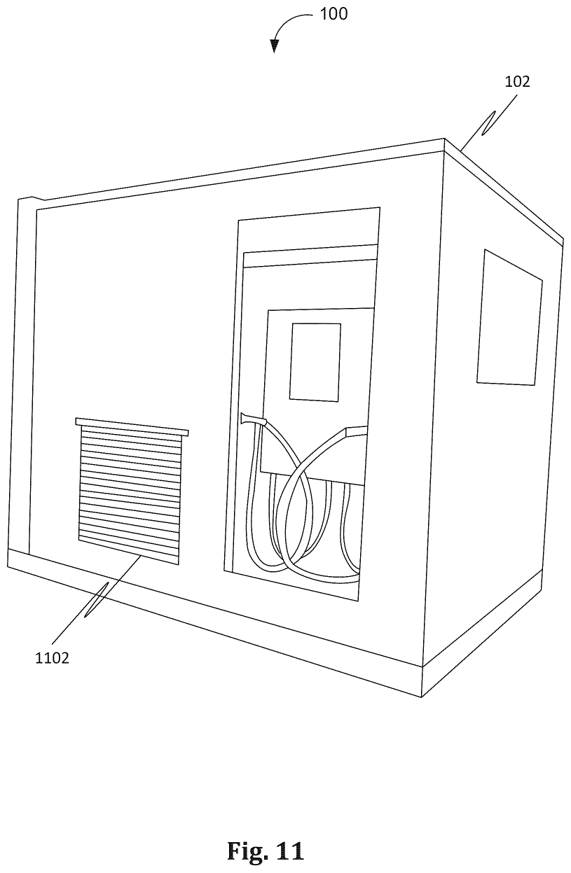

FIG. 11 illustrates the deployable power distribution system 100 including a heating, ventilation and air-conditioning (HVAC) unit 1102, in accordance with some embodiments. Further, in some embodiments, the deployable power distribution system may further include the heating, ventilation and air-conditioning (HVAC) unit 1102 coupled to the housing unit 102. Further, the HVAC unit 1102 may be configured for maintaining one or more of a predetermined temperature and a predetermined airflow within the housing unit 102.

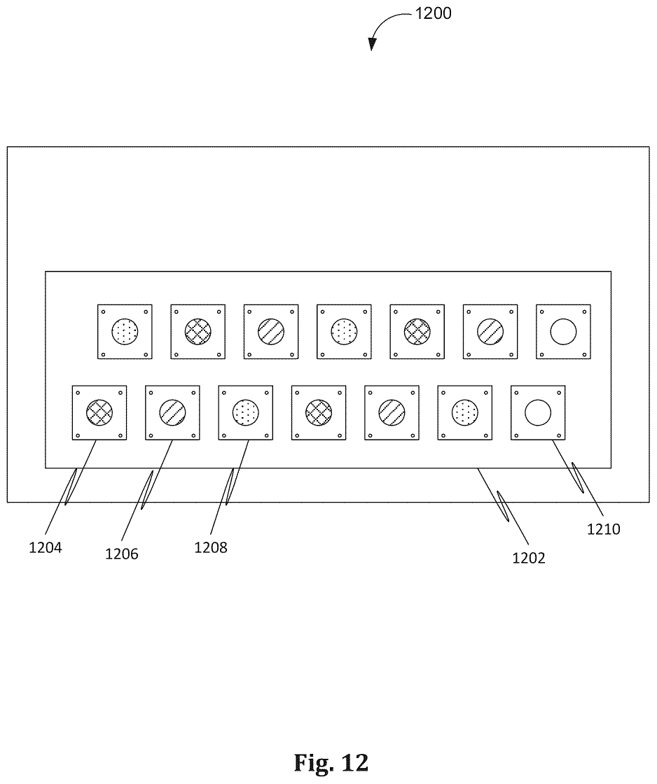

Referring to FIG. 12 a deployable power distribution system 1200 having an external system interface 1202 is shown. The external system interface 1202 may include a Power And Communication Transfer Access Point (PACTAC) interface. In an embodiment, the PACTAC interface includes one or more of a data and power connection point 1204, chargeable device connection point 1206, a Point of Sale (POS) connection point 1208, and an antenna connection point 1210.

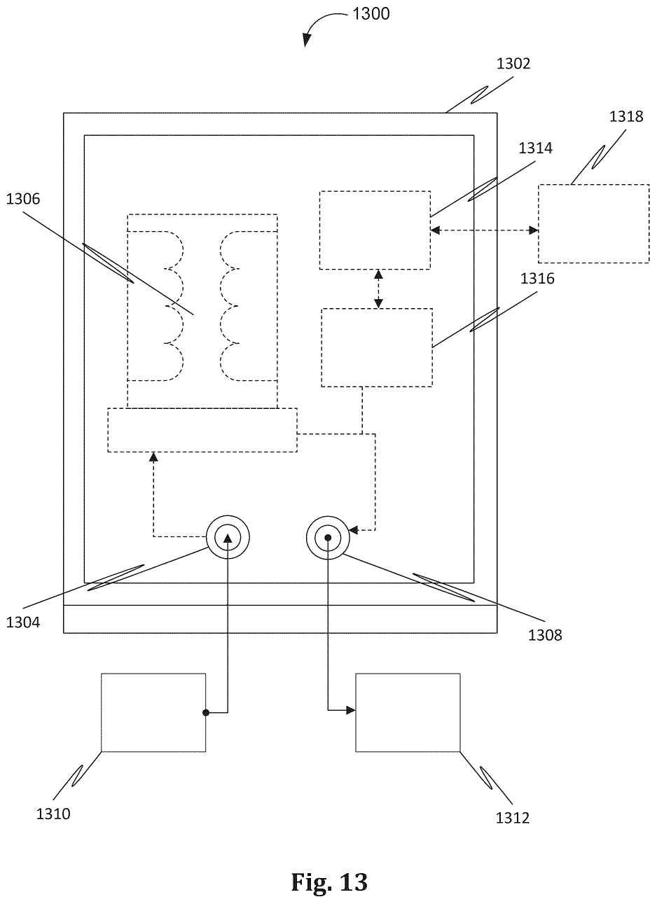

FIG. 13 illustrates a front view of a deployable power distribution system 1300, in accordance with some embodiments. Accordingly, the deployable power distribution system 1300 may include a housing unit 1302. Further, the housing unit 1302 may include one or more input connectors 1304 which may be configured for receiving an electrical input from one or more external sources 1310. Further, the housing unit 1302 may include one or more transformer modules 1306 electrically coupled with the one or more input connectors 1304. Further, the one or more transformer modules 1306 may be configured for modifying one or more attributes of the electrical input. Further, the one or more transformer modules 1306 may be configured for generating an electrical output based on the modifying of the one or more attributes. Further, the housing unit 1302 may include one or more output connectors 1308 electrically coupled with the one or more transformer modules 1306. Further, the one or more output connectors 1308 may be configured for distributing the electrical output to one or more loads 1312. Further, the deployable power distribution system 1300 may include a communication module 1314 disposed within the housing unit 1302. Further, the communication module 1314 may be configured for receiving one or more commands from one or more devices 1318. Further, the one or more commands includes a distribution command for distributing the electrical output. Further, the deployable power distribution system 1300 may include a processor 1316 communicatively coupled with the communication module 1314 and the one or more output connectors 1308. Further, the processor 1316 may be configured for analyzing the one or more commands. Further, the processor 1316 may be configured for initiating the distributing of the electrical output to the one or more loads 1312 based on the analyzing of the one or more commands.

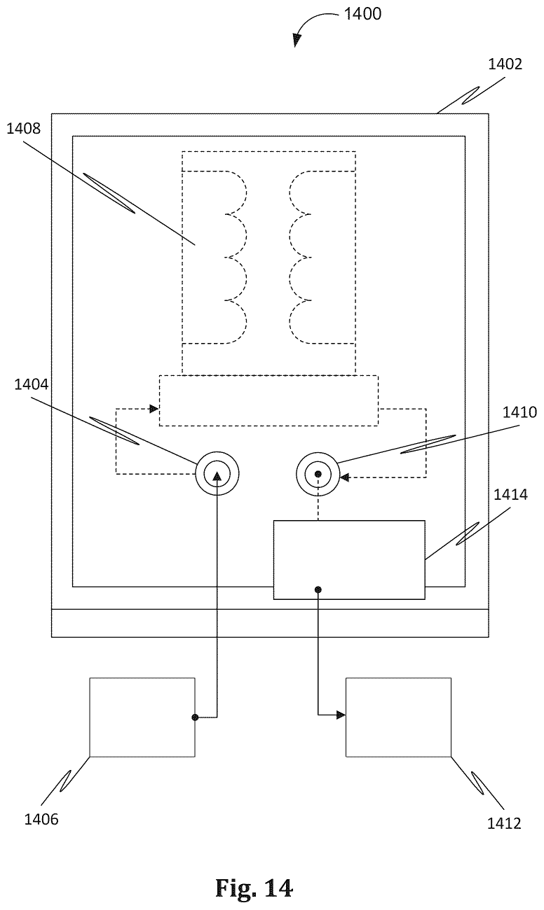

FIG. 14 illustrates a perspective view of a deployable power distribution system 1400, in accordance with some embodiments. Accordingly, the deployable power distribution system 1400 may include a housing unit 1402. Further, the housing unit 1402 may include one or more input connectors 1404 which may be configured for receiving an electrical input from one or more external sources 1406. Further, the housing unit 1402 may include one or more transformer modules 1408 electrically coupled with the one or more input connectors 1404. Further, the one or more transformer modules 1408 may be configured for modifying one or more attributes of the electrical input. Further, the one or more transformer modules 1408 may be configured for generating an electrical output based on the modifying of the one or more attributes. Further, the housing unit 1402 may include one or more output connectors 1410 electrically coupled with the one or more transformer modules 1408. Further, the one or more output connectors 1410 may be configured for distributing the electrical output to one or more loads. Further, the one or more loads include one or more chargeable devices 1412. Further, the deployable power distribution system 1400 may include one or more charging modules 1414 electrically coupled with the one or more output connectors 1410. Further, the distributing of the electrical output to the one or more loads includes charging the one or more chargeable devices 1412 using the one or more charging modules 1414.

In some embodiments, the one or more interfaces include a point-of-sale interface.

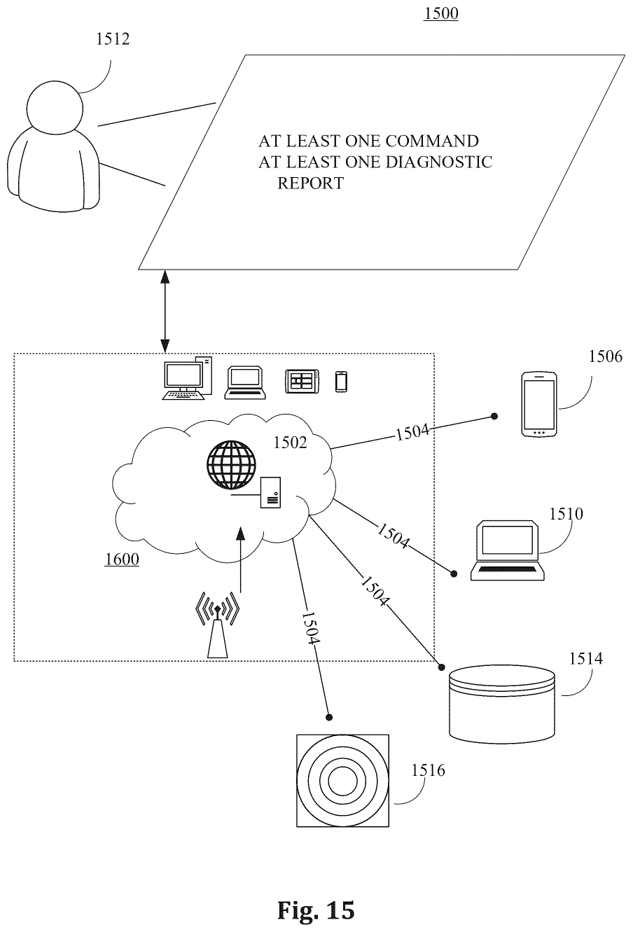

FIG. 15 is an illustration of an online platform 1500 consistent with various embodiments of the present disclosure. By way of non-limiting example, the online platform 1500 may be hosted on a centralized server 1502, such as, for example, a cloud computing service. The centralized server 1502 may communicate with other network entities, such as, for example, a mobile device 1506 (such as a smartphone, a laptop, a tablet computer etc.), other electronic devices 1510 (such as desktop computers, server computers etc.), databases 1514, and sensors 1516 over a communication network 1504, such as, but not limited to, the Internet. Further, users of the online platform 1500 may include relevant parties such as, but not limited to, end-users, administrators, service providers, service consumers and so on. Accordingly, in some instances, electronic devices operated by the one or more relevant parties may be in communication with the platform.

A user 1512, such as the one or more relevant parties, may access online platform 100 through a web based software application or browser. The web based software application may be embodied as, for example, but not be limited to, a website, a web application, a desktop application, and a mobile application compatible with a computing device 1600.

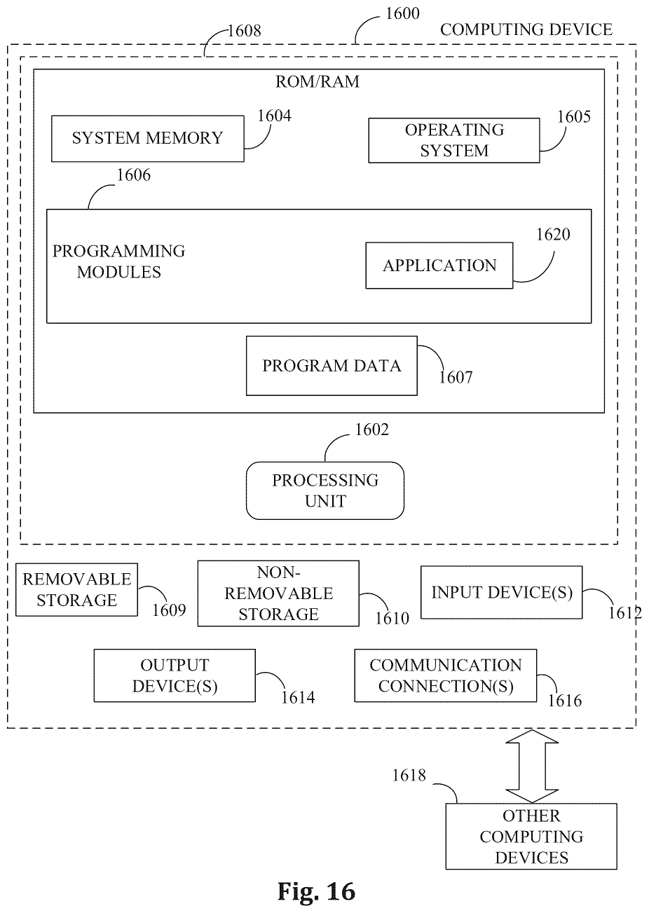

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A deployable power distribution system comprising a housing unit, wherein the housing unit comprises:
at least one input connector configured for receiving an electrical input from at least one external source;
at least one transformer module electrically coupled with the at least one input connector, wherein the at least one transformer module is configured for:
modifying at least one attribute of the electrical input; and
generating an electrical output based on the modifying of the at least one attribute; and
at least one output connector electrically coupled with the at least one transformer module, wherein the at least one output connector is configured for distributing the electrical output to at least one load.

2. The deployable power distribution system of claim 1, wherein the at least one load comprises at least one chargeable device, wherein the deployable power distribution system further comprises at least one charging module electrically coupled with the at least one output connector, wherein the distributing of the electrical output to the at least one load comprises charging the at least one chargeable device using the at least one charging module.

3. The deployable power distribution system of claim 1 further comprising at least one battery unit operatively coupled with the at least one transformer module, wherein the at least one battery unit is further electrically coupled with the at least one output connector, wherein the at least one battery unit is configured for storing the electrical output, wherein the distributing of the electrical output to the at least one load comprises distributing the electrical output from the at least one battery unit to the at least one load.

4. The deployable power distribution system of claim 1, wherein the receiving of the electrical input from the at least one external source comprises receiving the electrical input from the at least one external source using at least one connecting cable, wherein the at least one connecting cable comprises a first cable end and a second cable end, wherein the first cable end is coupled with the at least one input connector and the second cable end is coupled with the at least one external source.

5. The deployable power distribution system of claim 4, wherein the at least one connecting cable comprises a first cable connector disposed on the first cable end a second cable connector disposed on the second cable end, wherein the coupling of the first cable end with the at least one input connector comprises coupling the first cable end with the at least one input connector using the first cable connector, wherein the coupling of the second cable end with the at least one external source comprises coupling the second cable end with the at least one external source using the second cable connector.

6. The deployable power distribution system of claim 1 further comprising:
a communication module disposed within the housing unit, wherein the communication module is configured for receiving at least one command from at least one device, wherein the at least one command comprises a distribution command for distributing the electrical output; and
a processor communicatively coupled with the communication module and the at least one output connector, wherein the processor is configured for:
analyzing the at least one command; and
initiating the distributing of the electrical output to the at least one load based on the analyzing of the at least one command.

7. The deployable power distribution system of claim 6, wherein the communication module comprises a Wi-Fi transceiver module, wherein the receiving of the at least one command from the at least one device comprises receiving the at least one command from the at least one device using the Wi-Fi transceiver module.

8. The deployable power distribution system of claim 6, wherein the processor is further configured for:
determining at least one characteristic associated with the distributing of the electrical output to the at least one load; and
generating an interface data representing at least one interface based on determining of the at least one characteristic, wherein the deployable power distribution system further comprises at least one presentation device disposed on the housing unit, wherein the at least one presentation device is further communicatively coupled with the processor, wherein the at least one presentation device is configured for presenting the at least one interface to at least one user based on the interface data.

9. The deployable power distribution system of claim 8, wherein the at least one characteristic comprises a quantity of the electrical output, wherein the processing device is further configured for generating a cost data based on the determining of the quantity of the electrical output, wherein the cost data represents a cost associated with the distributing of the electrical output, wherein the presenting of the at least one interface comprises presenting the cost data to the at least one user.

10. The deployable power distribution system of claim 1 further comprising a fire suppression module disposed within the housing unit, wherein the fire suppression module is configured for:
monitoring a thermal condition associated with the deployable power distribution system;
detecting at least one combustion event based on the monitoring of the thermal condition; and
discharging at least one fire suppressant material based on the detecting of the at least one combustion event.

11. The deployable power distribution system of claim 6, wherein the processor is further configured for:
monitoring at least one operational parameter associated with the deployable power distribution system; and
generating at least one diagnostic report based on the monitoring of the at least one operational parameter, wherein the communication device is further configured for transmitting the at least one diagnostic report to the at least one device.

12. The deployable power distribution system of claim 5 further comprising a cable management unit disposed within the housing unit, wherein the cable management unit facilitates at least one of a structured deployment and containment of the at least one connecting cable.

13. The deployable power distribution system of claim 1 further comprises a heating, ventilation, and air-conditioning (HVAC) unit coupled to the housing unit, wherein the HVAC unit is configured for maintaining at least one of a predetermined temperature and a predetermined airflow within the housing unit.

14. The deployable power distribution system of claim 1, wherein the at least one transformer module comprises a 30 kVA transformer module, wherein the 30 kVA transformer module comprises a primary winding connected to a 480 A and 277 V supply and a secondary winding rated at 100 A and 12208 V.

15. The deployable power distribution system of claim 1, wherein the electrical output is at least one of a single-phase 120/240 V AC output and a three-phase 120/208 V AC output.

16. The deployable power distribution system of claim 2, wherein the at least one chargeable device comprises at least one electrical vehicle, wherein the at least one charging module comprises at least one electric vehicle supply equipment, wherein the charging of the at least one chargeable device using the at least one charging module comprises charging the at least one electrical vehicle using the at least one electric vehicle supply equipment.

17. The deployable power distribution system of claim 16, wherein the at least one electric vehicle supply equipment comprises at least one of at least one level 2 AC charging interface and at least one level 3 DC charging interface.

18. The deployable power distribution system of claim 1, wherein the at least one external source comprises at least one of a grid-tied system and a generator set system, wherein the grid-tied system comprises a solar-based system, wherein the generator set system comprises at least one of a diesel generator system and a natural gas generator system.

19. A deployable power distribution system comprising:
a housing unit comprising:
at least one input connector configured for receiving an electrical input from at least one external source;
at least one transformer module electrically coupled with the at least one input connector, wherein the at least one transformer module is configured for:
modifying at least one attribute of the electrical input; and
generating an electrical output based on the modifying of the at least one attribute; and
at least one output connector electrically coupled with the at least one transformer module, wherein the at least one output connector is configured for distributing the electrical output to at least one load;
a communication module disposed within the housing unit, wherein the communication module is configured for receiving at least one command from at least one device, wherein the at least one command comprises a distribution command for distributing the electrical output; and
a processor communicatively coupled with the communication module and the at least one output connector, wherein the processor is configured for:
analyzing the at least one command; and
initiating the distributing of the electrical output to the at least one load based on the analyzing of the at least one command.

20. A deployable power distribution system comprising:
a housing unit comprising:
at least one input connector configured for receiving an electrical input from at least one external source;
at least one transformer module electrically coupled with the at least one input connector, wherein the at least one transformer module is configured for:
modifying at least one attribute of the electrical input; and
generating an electrical output based on the modifying of the at least one attribute;
at least one output connector electrically coupled with the at least one transformer module, wherein the at least one output connector is configured for distributing the electrical output to at least one load, wherein the at least one load comprises at least one chargeable device; and
at least one charging module electrically coupled with the at least one output connector, wherein the distributing of the electrical output to the at least one load comprises charging the at least one chargeable device using the at least one charging module.
